(19) United States
(12) Patent Application Publication
(10) Pub. No.: US 2012/0260956 A1
(43) Pub. Date: Oct. 18, 2012

(54) CLEANING DEVICE FOR CLEANING HOLDER OF LENS MODULE

(75) Inventor: SHAO-KAI PEI, Tu-Cheng (TW)

(73) Assignee: HON HAI PRECISION INDUSTRY CO., LTD., Tu-Cheng (TW)

(21) Appl. No.: 13/113,948

(22) Filed: May 23, 2011

(30) Foreign Application Priority Data
Apr. 13, 2011 (TW) 100112872

(51) Int. Cl. B08B 3/00

(52) U.S. Cl. 134/198

(57) ABSTRACT

A cleaning device for cleaning holders includes a chamber, a rotatable component, a lifting component, a support component, and a jetting component. The rotatable component is positioned on an inner surface of the chamber. One end of the lifting component is connected to the rotatable component, and another end of the lifting component is connected to the support component. The supporting component supports the holders. The jetting component is positioned on another inner surface of the chamber and faces the support component. The jetting component includes water guns. The rotatable component rotates the lifting component and the support component. The lifting component moves the support component to a position where each high pressure water gun inserts into a corresponding holder.

### BACKGROUND

1. Technical Field

The present disclosure relates to a cleaning device for cleaning a holder of a lens module.

2. Description of Related Art

A camera module includes a barrel and a holder coupled to the barrel. The holder includes a plurality of internal screws. Generally, the holder is formed by injection molding.

Contaminants (e.g., plastic particles) at times remain inside of the holder, particularly, on the internal screws of the holder. In order to increase the yield rate of camera module, the holders are usually cleaned before assembly. Typically, the holders are placed into a washing tank with water for cleaning. However, because the water in the washing tank has a low flow rate, and the holders are small, it is difficult to remove the contaminants from the holders.

Therefore, it is desirable to provide a new cleaning device, which can overcome the above-mentioned limitations.

### BRIEF DESCRIPTION OF THE DRAWINGS

FIG. 1 is a partially cut-away, assembled view of a cleaning device according to an exemplary embodiment.

FIG. 2 is a perspective view of a typical holder.

FIG. 3 is an exploded view of the cleaning device of FIG. 1.

FIG. 4 is a perspective view of a support component of the cleaning device of FIG. 1 viewed from another angle.

FIG. 5 is a schematic view of the cleaning device of FIG. 1 in a first working state.

FIG. 6 is a perspective view of the support component coupled with a plurality of holders.

FIG. 7 is a schematic view of the cleaning device of FIG. 1 in a second working state.

FIG. 8 is a schematic view of the cleaning device of FIG. 1 in a third working state.

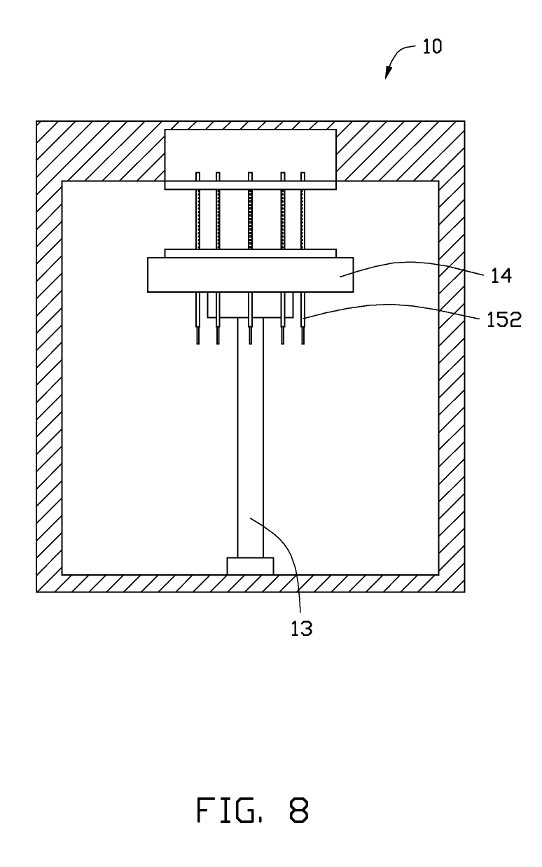

### DETAILED DESCRIPTION

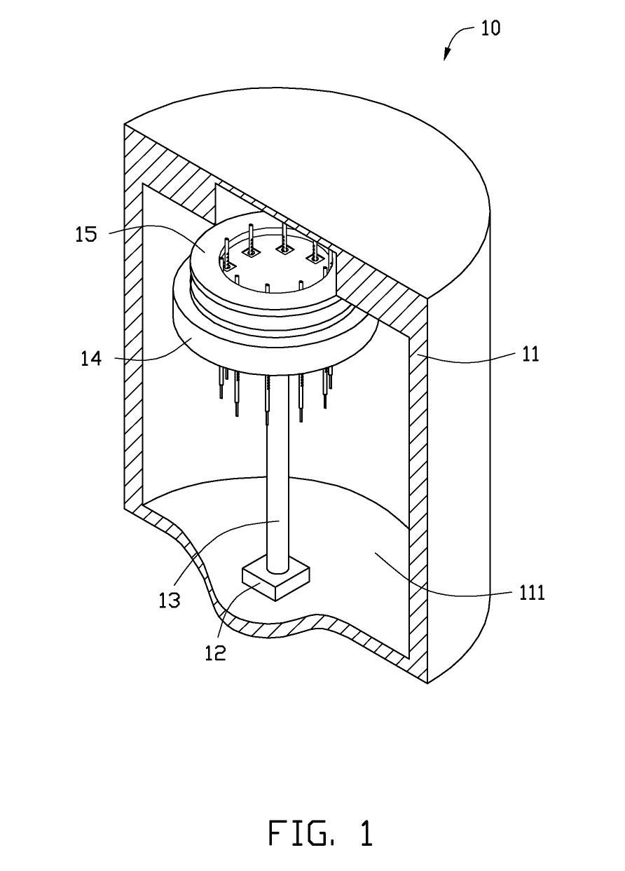

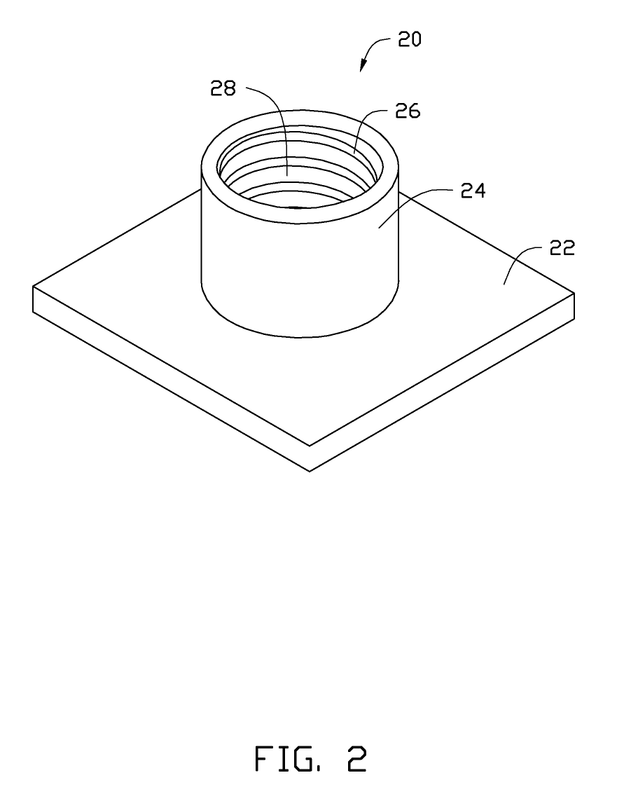

Referring to FIGS. 1 and 2, a cleaning device 10 for cleaning a holder 20 according to one embodiment is shown. The holder 20 includes a square base 22 and a cylindrical part 24. The holder 20 defines a through hole 28 for receiving a barrel (not shown). The cylindrical part 24 includes a plurality of internal screws 26. The holder 20 may have contaminants (e.g., small particles) on the internal screws 26.

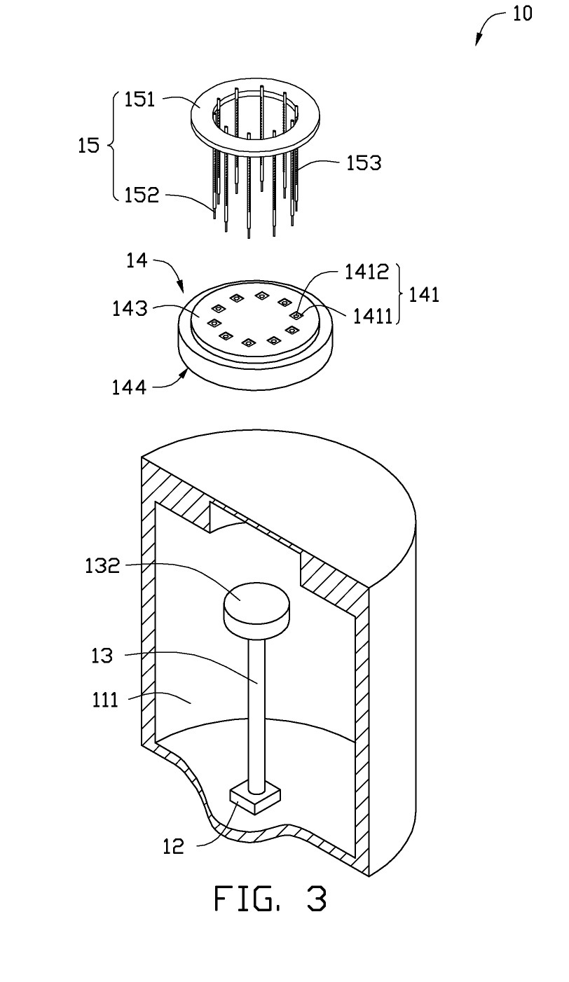

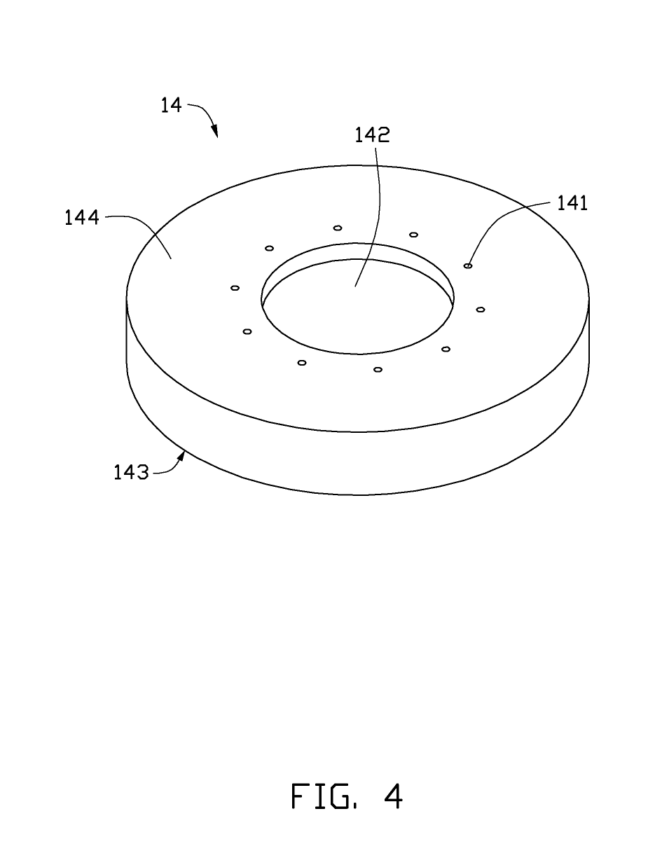

Referring also to FIGS. 3 and 4, the cleaning device 10 includes a chamber 11, and a rotatable component 12, a lifting component 13, a support component 14, and a jetting component 15. The rotatable component 12, the lifting component 13, the support component 14, and the jetting component 15 are received in the chamber 11.

The chamber 11 is substantially cylindrical, and defines a cylindrical space 111.

The support component 14 is substantially cylindrical, and includes a top surface 143 and a bottom surface 144. The support component 14 defines a plurality of receiving holes 141 extending from the top surface 143 to the bottom surface 144. Each receiving hole 141 accommodates the respective holder 20. The receiving holes 141 surround a central axis of the support component 14, and are equidistantly arranged in a circle centered in the central axis of the support component 14. A shape of each receiving hole 141 matches with that of the corresponding holder 20. In the present embodiment, each receiving hole 141 includes a square portion 1411 and a circular portion 1412 in an order from the top surface 143 to the bottom surface 144. The square portion 1411 couples with the square base 22, and the circular potion 142 couples with the cylindrical part 24. A recess 142 is defined in the bottom surface 144, and is configured for fixedly coupling with the lifting component 13 (described in detail later).

The jetting component 15 includes a ring-shaped body 151 and a plurality of high pressure water guns 152. The ring-shaped body 151 may be welded on a top wall of the chamber 11 or may be fixed by other methods. The high pressure water guns 152 are equidistantly arranged on an inner surface of the ring-shaped body 151. Each high pressure water gun 152 is inserted into the through hole 28 of a corresponding holder 20, and jets high pressure water towards an inner surface of the holder 20 to clean the holder 20. Each water gun 152 is a hollow tube and defines a plurality of equidistantly spaced jet openings 153. Each water gun 152 is connected to a high pressure water supply (not shown). A position of each water gun 152 corresponds to that of each receiving hole 141.

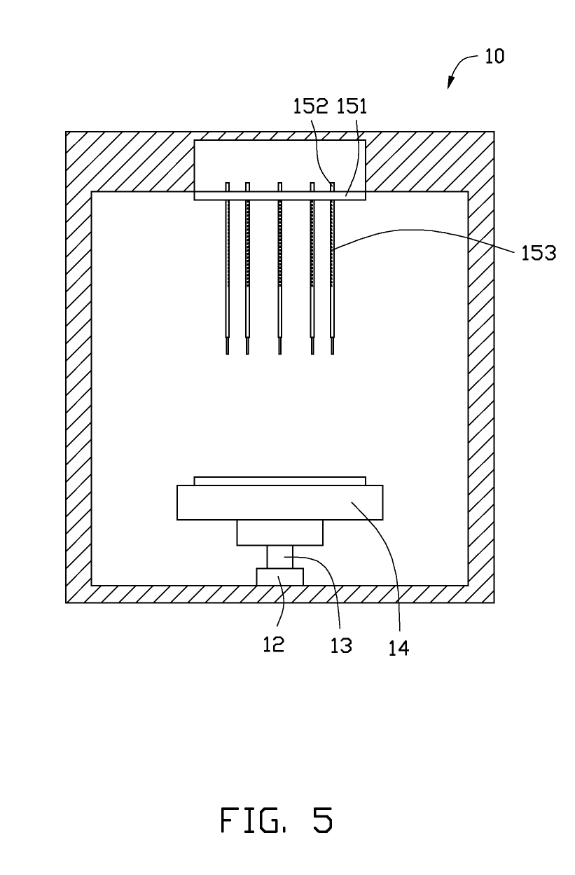

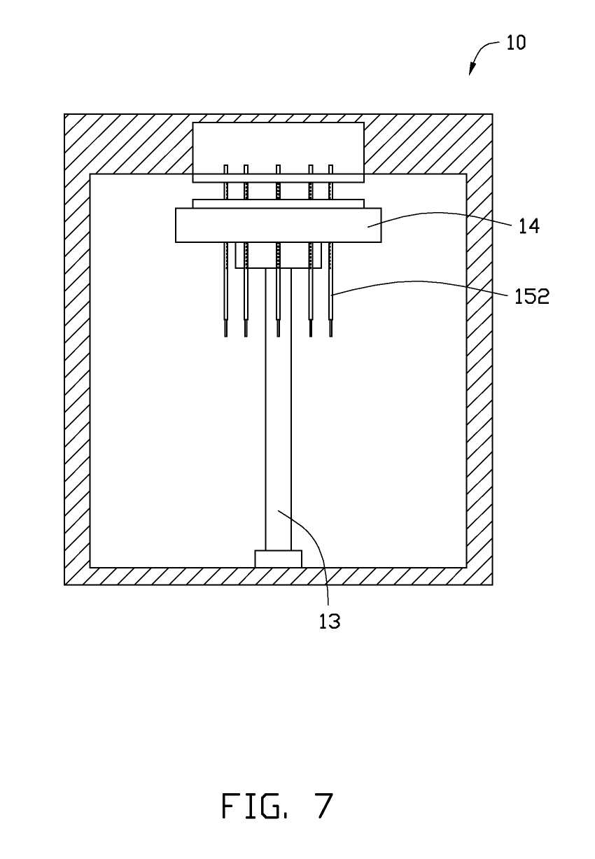

The lifting component 13 includes a cylindrical engagement part 132 formed on one end away from the rotatable component 12. The cylindrical engagement part 132 may be fixed in the recess 142 via screws. The lifting component 13 supports the support component 14, and drives the support component 14 to move between a first position and a second position along the lifting component 13. The lifting component 13 can be a hydraulic device. Referring to FIG. 5, when the support component 14 is in the first position, none of the water guns 152 is inserted into the through holes 28 of the holder 20. Referring to FIG. 7, when the support component 14 is in the second position, each water gun 152 is inserted into the through hole 28 of the corresponding holder 20, and jets high pressure water towards the inner surface of the holder 20 to clean the holder 20.

The rotatable component 12 is fixed at the bottom of the chamber 11, and is fixedly connected to the lifting component 13. The rotatable component 12 drives the lifting component 13 and the support component 14 to rotate in a high speed, thus removing water remaining in the holder 20 with centrifugal force. In the present embodiment, the rotatable component 12 is a motor.

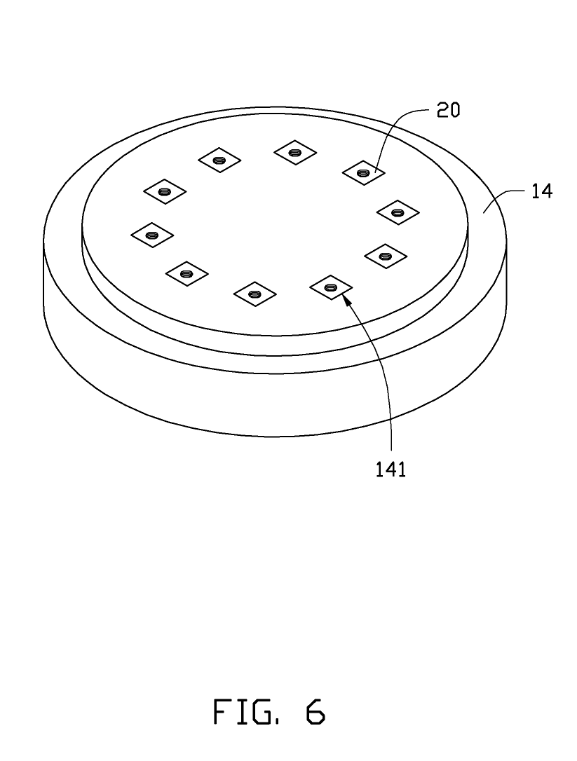

In operation, referring to FIG. 5, the support component 14 is brought to the first position by the lifting component 13, and a plurality of holders 20 are placed into the receiving holes 141 in a one-to-one relationship, as seen in FIG. 6.

Referring to FIG. 7, the lifting component 13 drives the support component 14 to the second position. In the second position, each water gun 152 is inserted into the through hole 28 of the corresponding holder 20 (referring to FIG. 2), and jets high pressure water. The lifting component 13 brings the support component 14 to move up and down repeatedly during the process of jetting high pressure water. In this way, the holders 20 are thoroughly cleaned.

Finally, referring to FIG. 5, the lifting component 13 brings the support component 14 to the first position, the rotatable component 12 drives the support component 14 to rotate at a high speed, thus removing water remained in the holders 20.

While various embodiments have been described, it is to be understood that the disclosure is not limited thereto. To the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. A cleaning device for cleaning a holder, the cleaning device comprising:
a support component for supporting the holder; and
a jetting component configured for jetting high pressure water into the holder to clean the holder.

2. The cleaning device of claim 1, further comprising a lifting component connecting to the support component, wherein the lifting component is capable of bringing the support component to a position where the jetting component jets the high pressure water into the holder.

3. The cleaning device of claim 2, wherein the lifting component comprises a hydraulic device.

4. The cleaning device of claim 1, further comprising a lifting component connecting to the support component, wherein the lifting component is capable of bringing the support component to move up and down repeatedly along the lifting component.

5. The cleaning device of claim 4, wherein the lifting component comprises a hydraulic device.

6. The cleaning device of claim 4, further comprising a rotatable component connected to the lifting component, wherein the rotatable component is configured for driving the support component to rotate such that water remained in the holder is removed due to a centrifugal force.

7. The cleaning device of claim 1, wherein the support component comprises a top surface and a bottom surface, the support component defines a receiving hole extending from the top surface to the bottom surface, and the receiving hole is for accommodating the holder.

8. The cleaning device of claim 1, wherein the jetting component comprises a high pressure water gun, the high pressure water gun defines a plurality of jet openings, and the water gun is configured to insert into the holder.

9. The cleaning device of claim 8, wherein the jet openings are evenly spaced.

10. The cleaning device of claim 8, wherein the jetting component is a hollow tube.

11. A cleaning device for cleaning holders, comprising:
a chamber;
a rotatable component positioned on an inner surface of the chamber;
a lifting component, one end of the lifting component being connected to the rotatable component;
a support component connecting to another end of the lifting component and configured for supporting the holders; and
a jetting component positioned on another inner surface of the chamber and facing the support component, the jetting component comprising a plurality of water guns, the rotatable component being capable of rotating the lifting component and the support component, the lifting component being capable of moving the support component to a position where each high pressure water gun inserts into a corresponding holder.

12. The cleaning device of claim 11, wherein the support component comprises a top surface and a bottom surface, the support component defines a plurality of receiving holes extending from the top surface to the bottom surface, and each receiving hole is configured for accommodating a corresponding holder.

13. The cleaning device of claim 11, wherein the jetting component further comprises a ring-shaped body, and the water guns are equidistantly arranged on an inner surface of the ring-shaped body.
